(19) United States
(12) Patent Application Publication
(10) Pub. No.: US 2004/0200653 A1
(43) Pub. Date: Oct. 14, 2004

(54) Beach buggy

(76) Inventor: Chien-Chang Ho, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/751,291

(22) Filed: Jan. 2, 2004

(30) Foreign Application Priority Data
Apr. 8, 2003 (TW) 92107982

(51) Int. Cl. B62M 7/00

(52) U.S. Cl. 180/224

(57) ABSTRACT

A beach buggy includes a frame, a rear wheel installed on the frame, a rear engine installed on the frame and operably connected with the rear wheel, a front wheel installed on frame and a front engine installed on the front fork and operably connected with the front wheel. The beach buggy includes a seat installed on a post extending from the frame.

### FIELD OF INVENTION

The present invention relates to a beach buggy.

### BACKGROUND OF INVENTION

Referring to FIGS. 5 and 6, a conventional beach buggy 100 is shown. The conventional beach buggy 100 includes a frame 110, an engine 120 installed on the frame 110, a transmission 130 installed on the frame 110 and operably connected with the engine 120, two rear wheels 140 installed on the frame 110 and operably connected with the transmission 130 and two front wheels 150 installed on the frame 110. Although the conventional beach buggy 100 can be used on the road, it is particularly if not only useful on a beach, hillside or the like. A rider who does not live on or by the beach, hillside or the like transports the conventional beach buggy 100 to the beach by means of a vehicle such as a pickup truck or super utility vehicle (“SUV”). Because of the use of four wheels, the conventional beach buggy 100 is bulky and therefore heavy. In fact, the conventional beach buggy 100 can be too heavy for the rider to move onto the pickup truck or SUV. The conventional beach buggy 100 can be too bulky for the SUV. The conventional beach buggy 100 is too heavy for the engine 120 to drive. The transmission 120 is complicated and expensive. The conventional beach buggy 100 will lose its ability to move if only one of its rear wheels is trapped in the sand. The present invention is therefore intended to obviate or at least alleviate the problems encountered in prior art.

### SUMMARY OF INVENTION

It is an objective of the present invention to provide a beach buggy that is small in size.

It is another objective of the present invention to provide a beach buggy that is light in weight.

It is another objective of the present invention to provide a beach buggy that is low in cost.

It is another objective of the present invention to provide a beach buggy that is strong in power.

According to the present invention, a beach buggy includes a frame, a rear wheel installed on the frame, a rear engine installed on the frame and operably connected with the rear wheel, a front wheel installed on frame and a front engine installed on the front fork and operably connected with the front wheel. The beach buggy includes a seat installed on a post extending from the frame.

Other objects, advantages and novel features of the invention will become more apparent from the following detailed description in conjunction with the attached drawings.

### BRIEF DESCRIPTION OF DRAWINGS

The present invention will be described via detailed illustration of embodiments referring to the drawings.

FIG. 1 is a perspective view of a beach buggy according to the preferred embodiment the present invention.

FIG. 2 is a right side view of the beach buggy shown in FIG. 1 with a cover removed.

FIG. 3 is another perspective view of the beach buggy of FIG. 1.

FIG. 4 is an exploded view of the beach buggy shown in FIG. 3.

FIG. 5 is a perspective view of a conventional beach buggy.

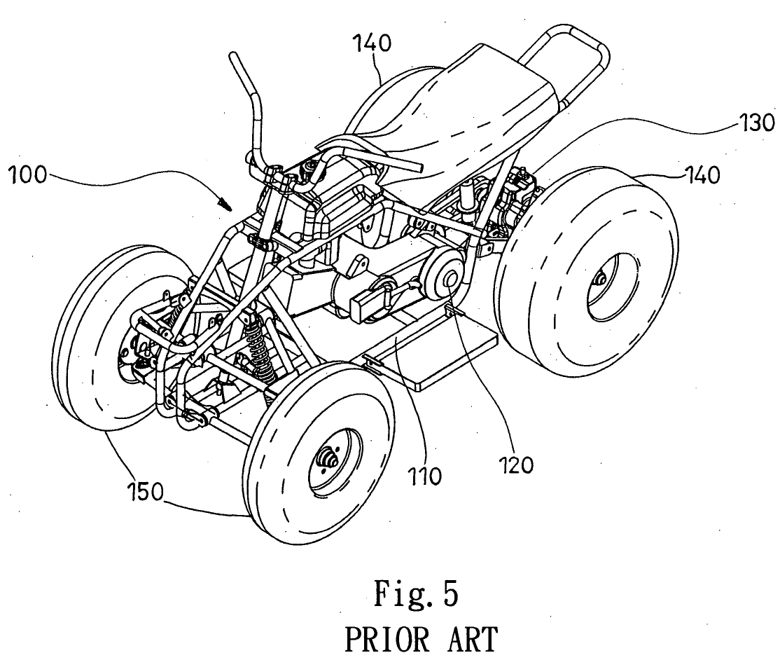

FIG. 6 is a top view of the beach buggy shown in FIG. 5.

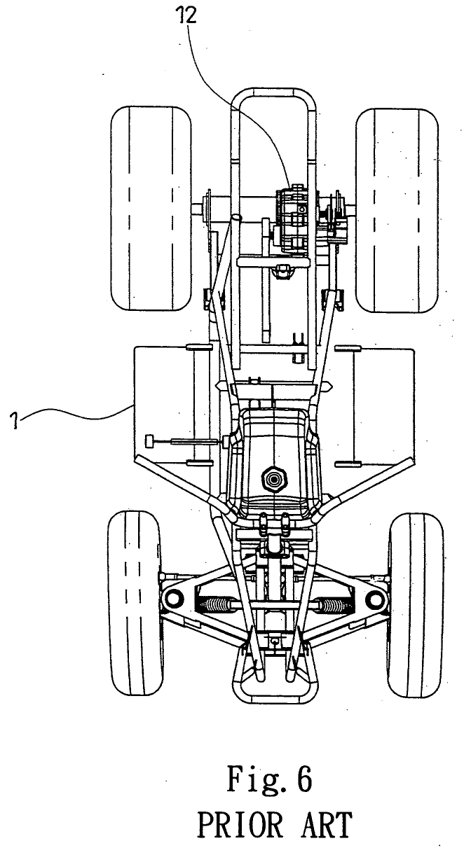

### DETAILED DESCRIPTION OF EMBODIMENTS

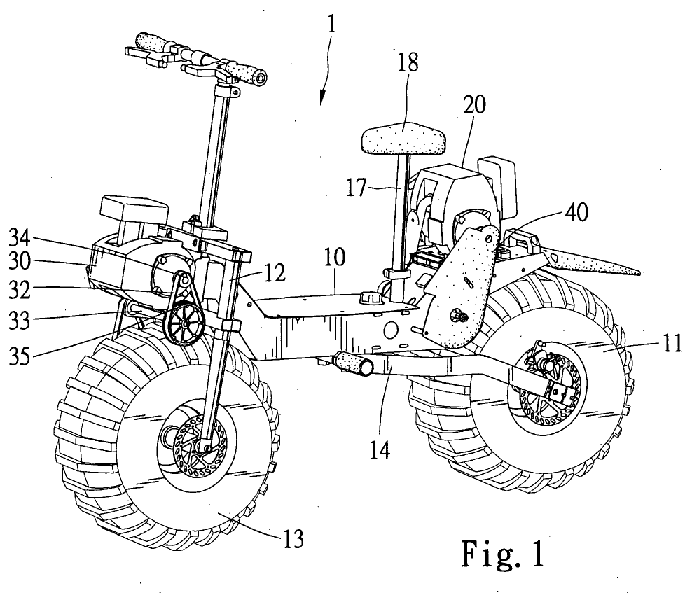

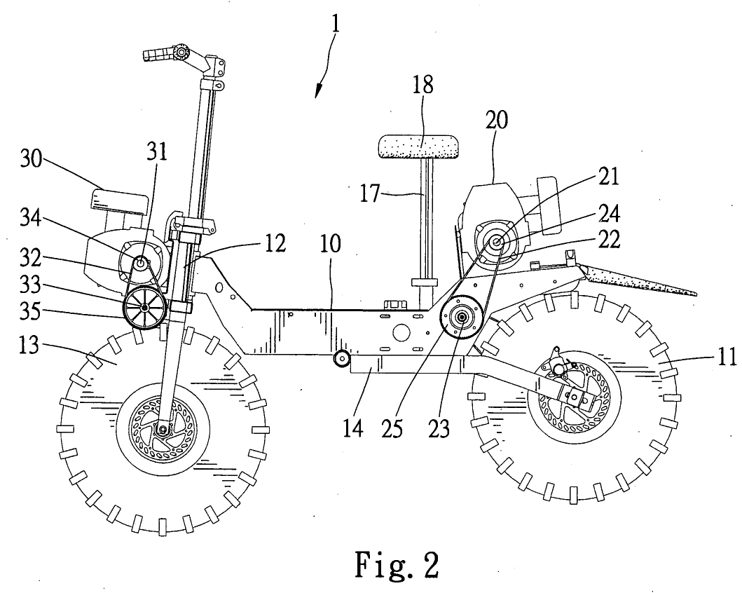

Referring to FIGS. 1 and 2, according to the preferred embodiment of the present invention, a beach buggy 1 includes a frame 10, a rear fork 14 connected with the frame 10, a rear wheel 11 installed on the frame 10, a rear engine 20 installed on the rear fork 14 and operably connected with the rear wheel 11, a front fork 12 connected with the frame 10, a front wheel 13 installed on the front fork 12 a front engine 30 installed on the front fork 12 and operably connected with the front wheel 13, a post 17 installed on the frame 10 and a seat 18 installed on the post 17.

The rear wheel 11 is put on the frame 10 as discussed above; however, it may be installed on the rear fork 14.

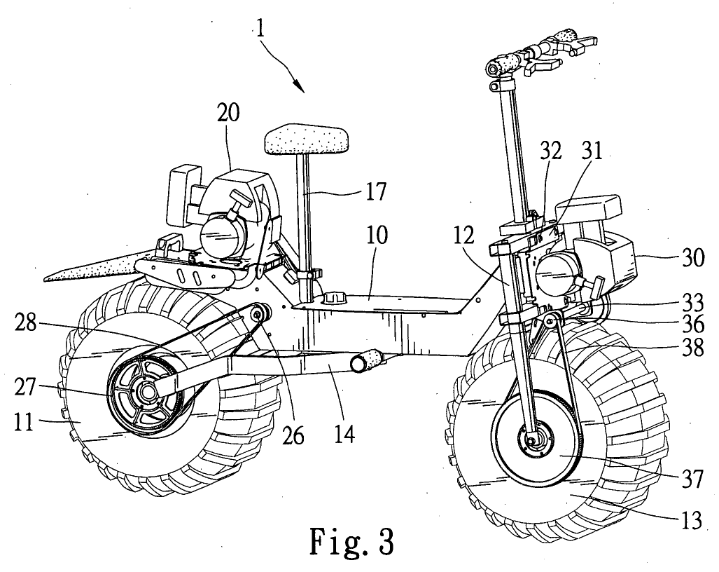

The rear engine 20 includes an axle 21. The rear engine 20 is operably connected with the rear wheel 11 via a rear transmission. Referring to FIGS. 2 and 3, the rear transmission includes an axle 23 extending across the frame 10, a pinion 24 installed on the axle 21, a gear 25 installed at an end of the axle 23, a belt or chain 22 for connecting the pinion 24 with the gear 25, a pinion 26 installed at an opposite end of the axle 23, a gear 27 attached to the rear wheel 11 and a belt or chain 28 for connecting the pinion 26 with the gear 27. Referring to FIG. 1, the rear transmission is covered by means of a cover 40.

The front engine 30 includes an axle 31. The front engine 30 is operably connected with the front wheel 13 via a front transmission. The front transmission includes an axle 33 installed on the front fork 12, a pinion 34 installed on the axle 33, a gear 35 installed at an end of the axle 33, a belt or chain 32 for connecting the pinion 34 with the gear 35, a pinion 36 installed at an opposite end of the axle 33, a gear 37 attached to the front wheel 13 and a belt or chain 38 for connecting the pinion 36 with the gear 37.

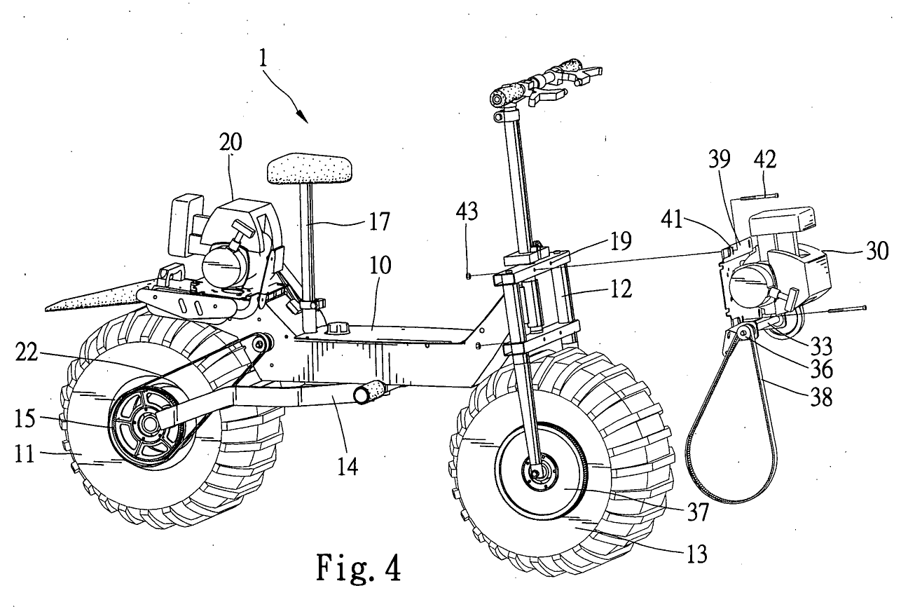

Referring to FIG. 4, the front engine 30 and the axle 33 are installed on a bracket 39 attached to the front fork 12. The fork 12 includes two apertures 19. The bracket 39 includes two apertures 41. A bolt 42 is brought into engagement with a nut 44 through each of the apertures 41 and corresponding one of the apertures 19. Thus, the bracket 39 is secured to the front fork 12.

The engines 20 and 30 can be started independent of each other. Thus, the wheels 11 and 13 are driven independent of each other. During an easy cruising, only one of the engines 20 and 30 is started. If the rider wants to ride on a steep slope or in a tough terrain, he or she starts both of the engines 20 and 30.

The beach buggy 1 is small in size and hence light in weight for including only two wheels 11 and 13. The beach buggy 1 is simple in structure and therefore light in weight for excluding any complicated steering system and complicated suspension system. The beach buggy 1 is low in cost for excluding any complicated steering system, complicated suspension system and complicated transmission. The beach buggy 1 is adequate in power for including two engines 20 and 30.

The present invention has been described via detailed illustration of the preferred embodiment. Those skilled in the art can derive variations from the preferred embodiment without departing from the scope of the present invention. Therefore, the preferred embodiment shall not limit the scope of the present invention defined in the claims.

What is claimed is:

1. A beach buggy comprising a frame, a rear wheel installed on the frame, a rear engine installed on the frame and operably connected with the rear wheel, a front wheel installed on frame and a front engine installed on the front fork and operably connected with the front wheel.

2. The beach buggy according to claim 1 including a post installed on the frame and a seat installed on the post.

3. The beach buggy according to claim 1 including a rear transmission for connecting the rear engine with the rear wheel.

4. The beach buggy according to claim 3 wherein the rear transmission includes an axle extending across the frame, a first pinion operably connected with the rear engine, a first gear installed at an end of the axle, a first transmitting element for connecting the first pinion with the first gear, a second pinion installed at an opposite end of the axle, a second gear attached to the rear wheel and a second transmitting element for connecting the second pinion with the second gear.

5. The beach buggy according to claim 4 wherein the first transmitting element is a belt.

6. The beach buggy according to claim 4 wherein the first transmitting element is a chain.

7. The beach buggy according to claim 4 wherein the second transmitting element is a belt.

8. The beach buggy according to claim 4 wherein the second transmitting element is a chain.

9. The beach buggy according to claim 1 including a front transmission for connecting the front engine with the front wheel.

10. The beach buggy according to claim 9 wherein the front transmission includes an axle extending across the frame, a first pinion operably connected with the front engine, a first gear installed at an end of the axle, a first transmitting element for connecting the first pinion with the first gear, a second pinion installed at an opposite end of the axle, a second gear attached to the front wheel and a second transmitting element for connecting the second pinion with the second gear.

11. The beach buggy according to claim 9 wherein the first transmitting element is a belt.

12. The beach buggy according to claim 9 wherein the first transmitting element is a chain.

13. The beach buggy according to claim 9 wherein the second transmitting element is a belt.

14. The beach buggy according to claim 9 wherein the second transmitting element is a chain.

15. The beach buggy according to claim 1 wherein the frame includes a rear fork installed thereon in order to support the rear wheel.

16. The beach buggy according to claim 1 wherein the frame includes a front fork installed thereon in order to support the front wheel.
